(19) United States
(12) Patent Application Publication
(10) Pub. No.: US 2016/0292169 A1
(43) Pub. Date: Oct. 6, 2016

(54) BOUNDING OR LIMITING DATA SETS FOR EFFICIENT SEARCHING BY LEVERAGING LOCATION DATA

(71) Applicant: International Business Machines Corporation, Armonk, NY (US)

(72) Inventors: Erik D. Anderson, Cedar Park, TX (US); David J. Carew, Austin, TX (US); Indran Naick, Cedar Park, TX (US)

(21) Appl. No.: 14/672,275

(22) Filed: Mar. 30, 2015

(51) Int. Cl. G06F 17/30

(52) U.S. Cl. CPC G06F 17/3087; G06F 17/3053; G06F 17/30554

(57) ABSTRACT

A method and system for utilizing application specific location information for presenting search results on a mobile device. The method and system includes generating an application specific context on a mobile device responsive to receiving content and location information by an application. The application can generate content and execute on the mobile device. Searching by the application is limited based on the location information and according to the application specific context. The search results are presented ordered by a ranking based on the application specific context and the location information.

### BACKGROUND

Mobile devices enable users to accomplish many tasks and retrieve information on many topics. More data and information may be accessed than a user may have time to peruse. In one example, the ability to retrieve relevant information quickly from a mobile device can be desirable. For example, a user may use their mobile device to capture information relevant to their location. In one example, a user may want to search movie theaters in their area, or restaurants in the area, or shopping center having a product they which to purchase that is in the area of their location. Other applications accessible using a mobile device may be more generic, for example, a calorie counting application. In one example, a user may have substantial information to review when researching restaurants in their locale, and the calories of specified foods.

### SUMMARY

According to an aspect of the present invention, a method utilizes application specific location information for presenting search results on a mobile device. The method includes generating an application specific context on a mobile device responsive to receiving location information by an application. The application can generate content and execute on the mobile device. Searching by the application is limited based on the location information and according to the application specific context. The search results are presented ordered by a ranking based on the application specific context and the location information.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is a schematic block diagram illustrating an overview of a system and methodology for utilizing application specific location information for presenting search results on a mobile device, according to an embodiment of the disclosure;

FIG. 2 is a flow chart illustrating a method for utilizing application specific location information for presenting search results on a mobile device based on FIG. 1, according to an embodiment of the disclosure; and

FIG. 3 is a schematic block diagram illustrating an overview of a system and methodology according to an embodiment of the disclosure.

### DETAILED DESCRIPTION

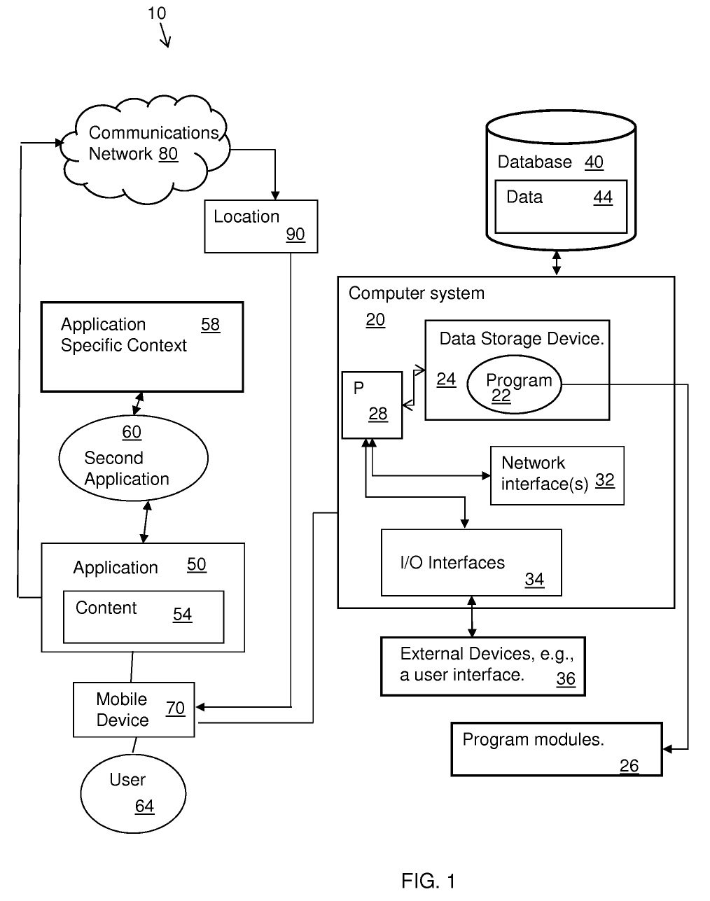

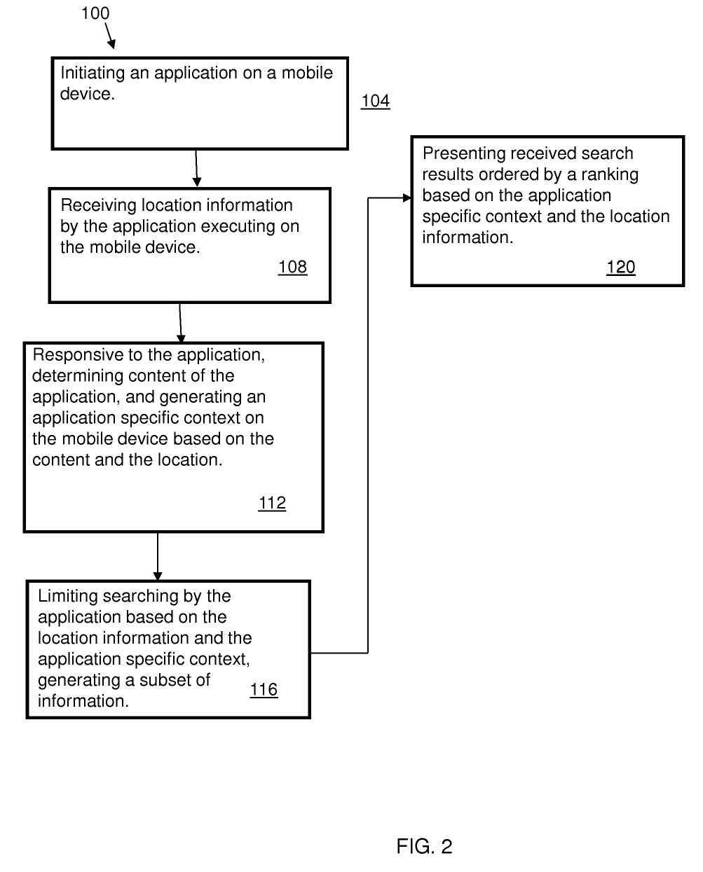

Referring to FIGS. 1 and 2, a system 10 and method 100 for utilizing application specific location information for presenting search results is discussed. The method 100 generates an application specific context on a mobile device responsive to receiving location information from an application, embodied as a first application 50 (also referred to as a first software application) executing on the mobile device 70, as in blocks 104, 108, 112. The first application can search for a product or service, or can be directed to a service which can apply, directly or indirectly, to an activity, product or service, or event, in the vicinity of the location of the user, or, stated another way, in a locale of the mobile device. A user 64 using their mobile device 70 at a location can access the first application which can use the location, for example, when searching for a service or product, or searching for data regarding a service or product. The first application 50 can be initiated on a mobile device by the user 64, as in block 104. The first application receives location information using the mobile device 70, as in block 108, for example, as the first application is executing on the mobile device. For example, the first application can access a GPS (Global Positioning System) using a communication network 80, to determine the location of the device 70. In one alternative, the functions of the first and second applications can also be modules of a single application.

Responsive to the first application, the method 100, embodied as a second application 60 (also referred to as a second software application), determines content 54 of the first application 50 (block 112), for example, a type or area of a product or service, or data generated by the application. The method 100, embodied as the second application 60, generates the application specific context 58 based on the content 54 from the first application 50 and the location 90, as in block 112. The search by the second application is limited or focused based on the location information and according to the content of the first application to generate the application specific context (as a subset of information), as in block 116.

The search results are presented ordered by a ranking based on the application specific context 58 and the location information 90 (block 120). Location based searching can use GPS (Global Positioning System) co-ordinates, cellular network triangulation, Wi-Fi location or IP address, or other wireless technologies to determine a location.

The content can define a category of venue, for example, food for sale in a location. The category of venue can include a product, a service, or data regarding the content of an application regarding an area or location. In one example, the application can locate restaurants in the vicinity of the user using a device. A calorie counting application for counting calories of foods can be an application providing specific context related to food. The application specific context can include menu items restricted to one or more restaurants in the vicinity. More specifically, a calorie counting application and the location information can identify a food court in a mall. The application specific context can include menu items from a set of restaurants in the food court and their calorie information.

The present disclosure works with an application on a mobile device to select a specific dataset (referred to as an application specific context) based on the location of the user. The application specific context can improve search response time and improve relevancy of ranked displaying of results. The present disclosure enables the user to receive relevant information quickly.

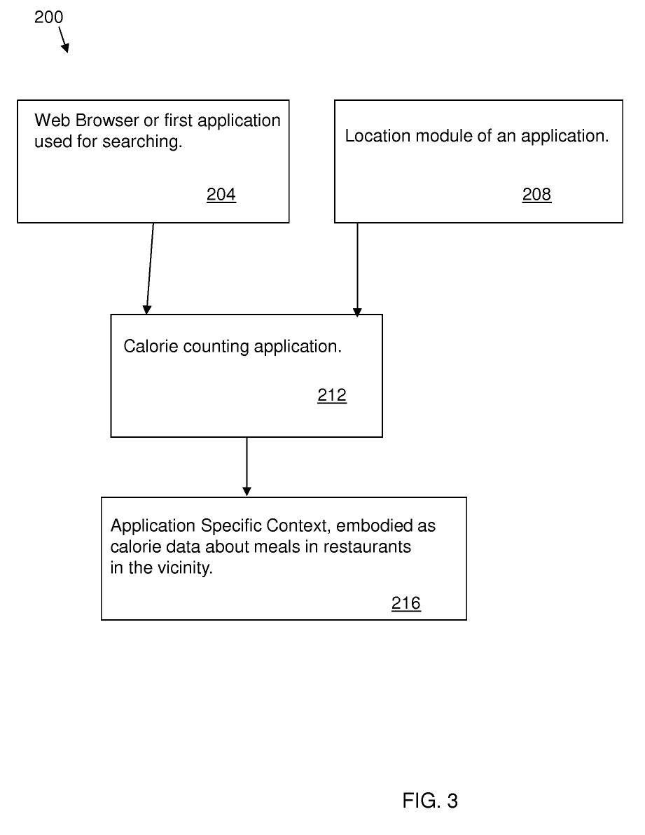

In one example according to an embodiment of the disclosure, referring to FIG. 3, a methodology 200 includes a first application to search for restaurants in the vicinity of the user/mobile device using a web browser or other application 204. The first application can use a location module 208 to ascertain the locale or vicinity of the mobile device and thereby the user. When a calorie counting application 212 is opened by the user, the calorie counting application provides calorie data about meals offered by restaurants in the vicinity as application specific context, as in block 216 (FIG. 3). This is in contrast to the calorie counting application providing generic or general data about meals, common meals or food, or calorie data in response to a search by the user. The calorie data about meals offered by restaurants in the vicinity is application specific context based on the content, which is food and calories of foods or meals, and the location, which is restaurants in the vicinity of the mobile device. Thereby, the present disclosure enhances or focuses search results to benefit the user, for instance, by saving the user time in searching for calorie data of the meals provided by nearby eating establishments.

In another example, the application can assist in meal planning, which can be provided by a meal planning application. An application can find a location in the vicinity of a grocery store. The application specific context can include ingredients available in the grocery store.

Thus, the present disclosure can determine the physical venue of the user, and then use the location information within a mobile application to refine an application's behavior or output.

In another example using a calorie counting application on a mobile device, a user can start the application. The application determines the user's physical location using a location determination technology, and makes an assumption based on the context of the application. The assumption can be that since the application is directed to food, the user is interested in foods in the vicinity of the user. Contextual information about the specific category or categories of venue that the application applies to can be coded into the application itself, and used to provide application specific context.

In another example, multiple categories of venue can be used in the case of a department store that may include, for example, groceries, clothing, hardware, and other items. Thereby, the application limits information to a subset of the relevant data which is relevant to the particular location, content of the application, and/or context otherwise indicated by the user. The user can then make selections from the subset of relevant data.

The users 64 may use the mobile device 70 to access a communications network 80 (for example, the Internet) to access location information such as from a GPS (Global Positioning System). The mobile device 70 is a generic representation for a plurality of user devices, for example, a computer, or a Personal Data Assistant (PDA), a cell phone, or a notebook, or the like. The device 70 is configured to send and receive electronic communications. The computer system 20 is a generic representation of a computer which may be embodied in a communications device such as a hand held device or mobile device, or can also represent a server for providing the method as a service which can be accessible using the Internet or a network.

The method 100 may be embodied in a program 22 (FIG. 1) embodied on a computer readable storage device, e.g., data storage device 24. The program 22 is executable by a processor 28 of a computer system 20 (to execute program steps, code, or program code). Additional data storage may also be embodied as a database 40 including data 44. The program or executable instructions may be offered as a service by a provider. The computer 20 and program 22 shown in FIG. 1 are generic representations of a computer and program that may be local to a user, or provided as a remote service, such as website accessible using a network (e.g., interacting with the Internet or cloud services). It is understood that the computer 20 also generically represents herein a computer device or a computer included in a device, such as a laptop or desktop computer, a mobile device, a personal data assistant (PDA), a netbook, a tablet computer, or one or more servers, alone or as part of a datacenter, or any type of computing device capable of running a program and accessing a network. The computer system 20 can include a network interface 32, and input/output (I/O) interface(s) 34. The I/O interface 34 allows for input and output of data with an external device 36 that may be connected to the computer system. The network interface 32 may provide communications between the computer system and a computer network. The method steps and system components and techniques may be embodied in modules of the program 22 for performing the tasks of each of the steps of the method and system, which are generically represented in FIG. 1 as program modules 26. The program 22 and program modules 26 can execute specific steps, routines, sub-routines, instructions or code, of the program.

It is understood that a computer or a program running on the computer may communicate with a server computer via a communications network. The communications network may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

Referring to FIG. 1, the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the htt noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The embodiments, features, and instructive examples described above are illustrative, and should not be construed to limit the present disclosure to the particular embodiments or enumerated examples. Thus, various changes and modifications may be effected by one skilled in the art without departing from the spirit or scope of the disclosure as defined in the appended claims.

What is claimed is:

1. A method for utilizing application specific location information for presenting search results on a mobile device, comprising:
generating an application specific context on a mobile device responsive to receiving content and location information by an application, the application generating content and executing on the mobile device;
limiting searching by the application based on the location information and according to the application specific context; and
presenting search results ordered by a ranking based on the application specific context and the location information.

2. The method of claim 1, further comprising:
defining a locale based on the location information;
identifying a product or a service in the locale which is related to the content of the application; and
associating the content of the application to the product or service to generate the application specific context.

3. The method of claim 1, wherein the content defines a category of venue.

4. The method of claim 3, wherein the category of venue includes: a product, a service, or data regarding the content.

5. The method of claim 1, wherein the location information identifies a restaurant in a locale of the mobile device, the application is a calorie count application, and the application specific context includes menu items restricted to the restaurant.

6. The method of claim 1, wherein the location information identifies a food court in a locale of the mobile device, the application is a calorie count application, and the application specific context includes menu items from a set of restaurants in the food court.

7. The method of claim 1, wherein the location information is a grocery store, the application is a meal planner application, and the application specific context includes ingredients available in the grocery store.

8. The method of claim 1, wherein the application is a first application, and a second application is used to generate the application specific context responsive to receiving the content and location information by the first application; and the method further comprising:
limiting searching by the first application based on the location information and according to the application specific context generated by the second application.

9. A computer program product for utilizing application specific location information for presenting search results on a mobile device, the computer program product comprising a computer readable storage medium having program instructions embodied therewith, wherein the computer readable storage medium is not a transitory signal per se, the program instructions executable by a computer to cause the computer to perform a method, comprising:
generating, by the computer, an application specific context on a mobile device responsive to receiving content and location information by an application, the application generating content and executing on the mobile device;
limiting searching, by the computer, by the application based on the location information and according to the application specific context; and
presenting search results, by the computer, ordered by a ranking based on the application specific context and the location information.

10. The computer program product of claim 9, further comprising:
defining a locale based on the location information;
identifying a product or a service in the locale which is related to the content of the application; and
associating the content of the application to the product or service to generate the application specific context.

11. The computer program product of claim 9, wherein the location information identifies a restaurant in a locale of the mobile device, the application is a calorie count application, and the application specific context includes menu items restricted to the restaurant.

12. The computer program product of claim 9, wherein the location information identifies a food court in a locale of the mobile device, the application is a calorie count application, and the application specific context includes menu items from a set of restaurants in the food court.

13. The computer program product of claim 9, wherein the location information is a grocery store, the application is a meal planner application, and the application specific context includes ingredients available in the grocery store.

14. The computer program product of claim 9, wherein the application is a first application, and a second application is used to generate the application specific context responsive to receiving the content and location information by the first application; and the method further comprising:
limiting searching by the first application based on the location information and according to the application specific context generated by the second application.

15. A computer system for utilizing application specific location information for presenting search results on a mobile device, the computer system comprising:
one or more computer processors, one or more computer-readable storage media, and program instructions stored on one or more of the computer-readable storage media for execution by at least one of the one or more processors, the program instructions, comprising:
generating an application specific context on a mobile device responsive to receiving content and location information by an application, the application generating content and executing on the mobile device;
limiting searching by the application based on the location information and according to the application specific context; and
presenting search results ordered by a ranking based on the application specific context and the location information.

16. The system of claim 15, further comprising:
defining a locale based on the location information;
identifying a product or a service in the locale which is related to the content of the application; and
associating the content of the application to the product or service to generate the application specific context.

17. The system of claim 15, wherein the location information identifies a restaurant in a locale of the mobile device, the application is a calorie count application, and the application specific context includes menu items restricted to the restaurant.

18. The system of claim 15, wherein the location information identifies a food court in a locale of the mobile device, the application is a calorie count application, and
the application specific context includes menu items from a set of restaurants in the food court.

19. The system of claim 15, wherein the location information is a grocery store, the application is a meal planner application, and the application specific context includes ingredients available in the grocery store.

20. The system of claim 15, wherein the application is a first application, and a second application is used to generate the application specific context responsive to receiving the content and location information by the first application; and the method further comprising:
limiting searching by the first application based on the location information and according to the application specific context generated by the second application.
